(19) United States
(12) Patent Application Publication
(10) Pub. No.: US 2021/0276441 A1
(43) Pub. Date: Sep. 9, 2021

(54) A COMPUTERIZED SYSTEM FOR GUIDING A MOBILE ROBOT TO A DOCKING STATION AND A METHOD OF USING SAME

(71) Applicant: INDOOR ROBOTICS LTD., RAMAT-GAN (IL)

(72) Inventors: DORON BEN-DAVID, RAMAT-GAN (IL); AMIT MORAN, TEL-AVIV (IL)

(21) Appl. No.: 17/049,586

(22) PCT Filed: Jun. 23, 2019
(86) PCT No.: PCT/IL2019/050700

§ 371 Date: Oct. 22, 2020

(30) Foreign Application Priority Data
Jun. 28, 2018 (IL) 260333

(51) Int. Cl. B60L 53/36; G05D 1/02; A47L 9/28

(52) U.S. Cl. CPC B60L 53/36; G05D 1/0225; G05D 1/0246; A47L 9/2852; A47L 2201/04; A47L 9/2894; A47L 9/2805; G05D 2201/0203; A47L 2201/022; A47L 9/2873

(57) ABSTRACT

The claimed subject matter discloses a method for guiding a mobile robot moving in an area to a docking station, the method comprising determining that the mobile robot is required to move to the docking station, the docking station obtaining a location and/or position of the mobile robot, upon detection of the mobile robots location in the area, calculating a navigation path from the mobile robots location to the docking station, the mobile robot moving towards the docking station in accordance to the calculated navigation path, identifying that the mobile robot is within a predefined distance from said docking station; and generating docking commands to the mobile robot when located within the predefined distance from said docking station until the mobile robot docks into the docking station.

### FIELD OF THE INVENTION

The present invention relates to devices for guiding mobile robots, more specifically devices for guiding mobile robots to docking stations.

### BACKGROUND OF THE INVENTION

The daily use of mobile robots, such as domestic vacuum cleaners, quadcopters and many others, increases constantly. Such mobile robots are designed to move in an area, either guided by a user or automatically, using navigation sensors such as cameras, sonars and the like. Typically, the mobile robots are equipped with a power source, such as a battery, enabling the robots to function without being physically connected to a power source. The power sources used by mobile robots are usually rechargeable, as many power sources allow several hours of work before the power depletes and the mobile robot needs to be recharged. Additionally, the amount of time between each charge (i.e. charge cycle) may vary in accordance with the mobile robot type, mobile robot functionality, tasks, environment and the like. For example, flying robots such as quadcopters have shorter charge cycle, while wheeled robots usually have longer charge cycles.

Due to the limited time for each charge cycle, some of the mobile robots are designed to return to their docking station for charging before the power in their power supply depletes. In some embodiments, mobile robots may be equipped with sensors and navigation modules in order to direct the mobile robot towards the docking station. When mobile robots detect the docking station, the mobile robots may navigate towards the docking station and eventually guide themselves for docking in the docking station for recharge.

However, the current methods for navigating the mobile robots to the docking station require significant computation power from the mobile robots, thus shortening the charge cycle. Additionally, the mobile robots may be burdened physically by additional weight and surface required for the sensors and equipment required for the docking. For example, Sensors require computing power that can be assigned for different tasks. Additionally, sensors located on the mobile robot may be damaged over time, covered by dust or otherwise malfunctioning. Therefore, there is a great need for improving the navigation of the mobile robots to the docking station without burdening the mobile robots.

### SUMMARY OF THE INVENTION

It is an object of the subject matter to disclose a method for guiding a mobile robot moving in an area to a docking station, the method comprising determining that the mobile robot is required to move to the docking station, the docking station obtaining a location and/or position of the mobile robot, upon detection of the mobile robot's location in the area, calculating a navigation path from the mobile robot's location to the docking station, the mobile robot moving towards the docking station in accordance to the calculated navigation path, identifying that the mobile robot is within a predefined distance from said docking station; and generating docking commands to the mobile robot when located within the predefined distance from said docking station until the mobile robot docks into the docking station.
In some cases, the method further comprises transmitting the calculated path to the mobile robot. In some cases, the one or more sensors are movable in the area, wherein the one or more sensors receive a command to locate the mobile robot inside the area, the one or more sensors moving in the area until locating the mobile robot. In some cases, the determining that the mobile robot is required to move to the docking station is performed according to charging properties of the mobile robot.
In some cases, the calculation of the navigation path is performed by a remote server communicating with the docking station.
In some cases, the method further comprising identifying the mobile robot within predefined distance from said docking station is performed according to images captured by a sensor module of the docking station.
In some cases, the method further comprising identifying the mobile robot within predefined distance from said docking station is performed according to images captured by a sensor module of the mobile robot.
In some cases, the method further comprising switching the mobile robot to an accurate command mode, in which the mobile robot only moves in response to specific commands from the docking station.
In some cases, the method further comprising the docking station receiving signals from multiple mobile robots, at least one of the multiple mobile robots exchanges signals with the mobile robot or captures an image of the mobile robot, and further comprising calculating the mobile robot's location according to the signals received from multiple mobile robots.
In some cases, the method further comprising the docking station receiving data collected by sensors located on the mobile robot, and further comprising calculating the mobile robot's location according to the data collected by sensors located on the mobile robot. In some cases, the docking station receives a position of the mobile robot and calculates the navigation path according to the mobile robot's location combined with the mobile robot's position.

It is another object of the subject matter to disclose a docking system for guiding a mobile robot moving in an area to a docking station, the docking station comprises a docking station, comprising at least one charging unit, a communication module configured to exchange data with said mobile robot; and a controller module comprising a processor, a memory and a sensor module comprising one or more sensors, wherein the sensor module is configured to track the mobile robot in the area once the mobile robot is required to move towards the docking station, wherein the sensor module indicates to the docking station when the mobile robot is located within a predetermined distance from the docking station, and wherein the docking station is configured to provide docking instructions to the mobile robot for connecting the mobile robot to the at least one charging unit.

In some cases, the sensor module is further configured to calculate a recharge navigation path and send the recharge navigation path to said mobile robot.
In some cases, the controller module is configured to generate commands for docking the mobile robot to the docking station when the mobile robot is within a predefined distance from the docking station. In some cases, the at least one sensor of the sensor module is movable in response to a command from the docking station.
In some cases, the docking system further comprising a secondary sensor module located in the area, remotely from the docking station, communicatively coupled with the docking station, wherein the docking station is configured to calculate the mobile robot's location according to information received from the secondary sensor module.
In some cases, the mobile robot is an autonomous vehicle and the area is a charging station.

### BRIEF DESCRIPTION OF THE DRAWINGS

The invention may be more clearly understood upon reading of the following detailed description of non-limiting exemplary embodiments thereof, with reference to the following drawings, in which:

FIG. 1 discloses a schematic block diagram of a docking station, according to exemplary embodiments of the subject matter;

FIG. 2 discloses a schematic block diagram of a mobile robot navigation system comprising a docking station, according to exemplary embodiments of the subject matter; and

FIG. 3 illustrates a method for navigating a mobile robot to a docking station, according to exemplary embodiments of the subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

The subject matter in the present invention discloses a device for guiding a mobile robot to a docking station, a system comprising the mobile robot, the docking station and the guiding device, and a method for using the docking station for guiding the mobile robot thereto. The term “recharge navigation” used herein depicts the navigating process and/or path of a mobile robot from a remote position to the docking station. The remote position may be the position in which the mobile robot received a command to move towards the docking station. The term “direction” as mentioned herein depicts the direction a front side of a mobile robot is facing. The term “position” refers to the mobile robot's position, for example tilting, bending, upright position and the like. The mobile robot's position may be represented by values of pitch/roll/yaw +x,y,z direction of a surface of the mobile robot's housing. For example, an exemplary position may be include a direction of the mobile robot's housing front surface. In some embodiments, some mobile robots might not have a position, such as symmetrical quadcopters. The term “location” as mentioned here, depicts the mobile robot's coordinates, either generally (such as GPS), or relative to another object (such as the distance and azimuth to the docking station).

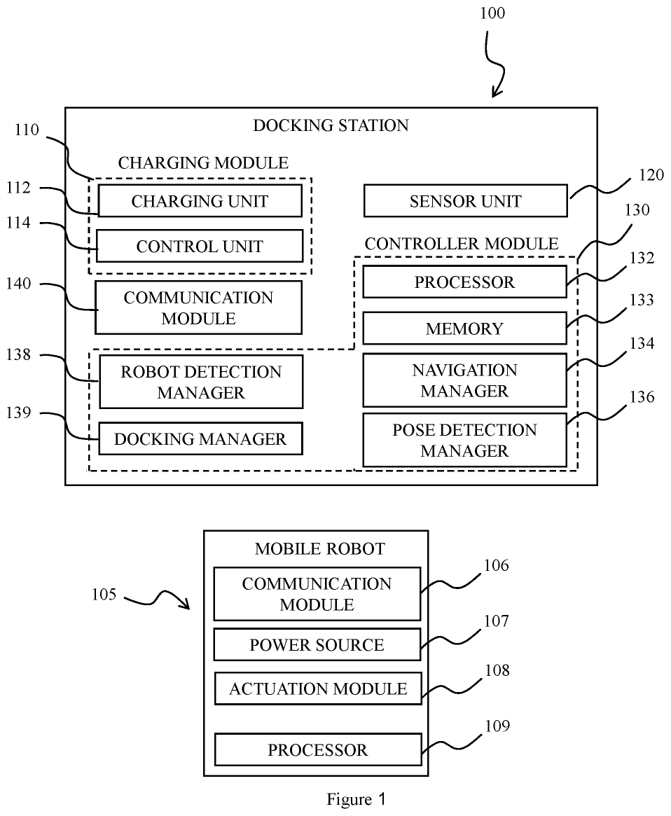

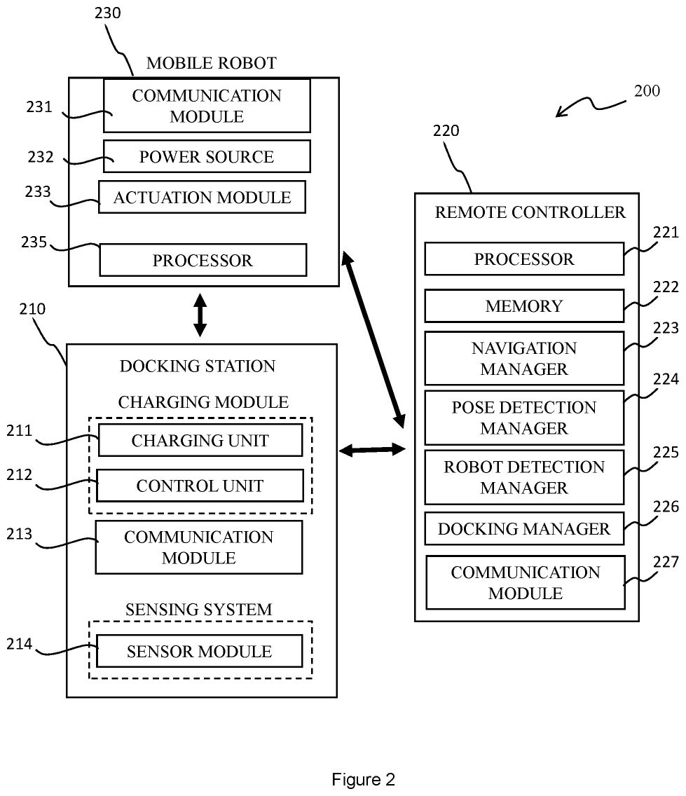

FIG. 1 discloses a schematic block diagram of a docking station, according to exemplary embodiments of the subject matter. FIG. 1 shows a docking station 100 configured to charge and guide at least one mobile robot 105. The at least one mobile robot 105 is a mobile device that is capable of navigating in an area. In some embodiments, the mobile robot may be configured to navigate either in a domestic area, industrial area or outdoors. The mobile robot may be an autonomous vehicle and the area may be a charging station. Examples of mobile robots include aerial robots such as quadcopters, ground robots such as robot vacuum cleaners and automatic ground vehicles or water robots such as pool cleaning robots. In some embodiments, the mobile robot 105 is configured to receive instructions from and be charged by the docking station 100. The mobile robot 105 comprises a communication module 106 and a power source 107. In some cases, the power source 107 should be sufficiently large for enabling a sufficient amount of voltage, which enables sufficient performance without connecting the mobile robot 105 to an electrical grid or another external power source. The mobile robot 105 also comprises an actuation module 108 and a processor 109, as elaborated in FIG. 2.

In some embodiments, the docking station 100 comprises: a charging module 110, a sensing module 120, a controller module 130 and a communication module 140. The communication module 140 is configured to exchange data either in a wired or wireless manner. In some embodiments, the docking station 100 is connected to a power grid for receiving and distributing power therefrom. In other embodiments, the docking station 100 may receive power from a local power source such as solar panels, battery and the like.

The charging module 110 of the docking station 100 is configured to supply power to at least one mobile robot 105. The charging module 110 may comprise at least one charging unit 112 and a control unit 114. In some embodiments, the at least one charging unit 112 is a single charging module configured to charge a single mobile robot 105. In further embodiments, the charging module 110 comprises two or more charging units configured to charge more than one mobile robot 105 simultaneously, wherein each mobile robot is charged by a single charging unit such as the charging unit 112. In some embodiments, a single charging module 110 may charge a plurality of mobile robots (for example, in a wireless manner).

The sensing unit 120 of the docking station 100 is configured to use a plurality of sensors to gather data. In some embodiments, the data gathered by the sensing unit 120 may be used to track the location and/or position of a mobile robot 105, and to calculate the distance of the mobile robot 105 from the docking station 100. In some embodiments, the sensor unit 120 comprises a plurality of sensors, for example cameras, environmental sensors, temperature sensor, smoke sensor, acoustic sensor and the like. The plurality of sensors of the sensor unit 120 may comprise optical sensors such as: RGB cameras, IR camera and the like; and electromagnetic sensors for measuring electromagnetic signals; sonar, radar and the like.

The controller module 130 may be embedded in the docking station 100 and is configured to guide the mobile robot 105 towards the docking station 100. In some exemplary embodiments, the components and functionality of the controller module 130 are located in a remote server in communication with the docking station 100, for example located on a web server. In some cases, the controller module 130 is configured to guide multiple mobile robots towards the docking station 100. In some embodiments, the controller module 130 may be configured to receive the data collected by the sensor unit 120 of the mobile robot 105 and process the collected data in order to guide the mobile robot. In some cases, the data collected by the sensor unit 120 of the mobile robot 105 is sent for processing on a remote server in communication with the docking station 100 or with the controller module 130. In some embodiments, the controller module 130 comprises a processor 132 and a memory 133. In some embodiments, the controller module 130 is capable of operating a plurality of software operations using the processor 132 thereof In some embodiments, the docking station 100 is configured to operate the following operations: a robot detection manager 134, a pose detection manager 136, a navigation manager 138 and a docking manager 139.

The robot detection manager 134 is configured to calculate the mobile robot's location according to the data gathered from the sensor unit 120 and store the robot's location in the memory 133. In some embodiments, mobile robot's location 105 is calculated in a general manner (i.e. relative to the earth, such as using GPS sensors located on the mobile robot, indoor positioning system and the like). In other embodiments, the mobile robot's location is calculated relative to the docking station 100, or generally. In some embodiments, the robot detection manager 134 may utilize optical sensors to measure the distance to the mobile robot 105 when the mobile robot 105 is in a line of sight from the docking station 100. In further embodiments, the robot detection manager 134 may estimate the distance of the mobile robot 105 from the docking station 100 based on measuring a WI-FI signal strength the mobile robot 105 is transmitting. In some cases, a sensor the sensor unit 120 with a known location calculates the mobile robot's distance and direction from the sensor, and the robot detection manager 134 calculates the mobile robot's location accordingly. In some exemplary cases, the sensor unit 120 may comprise a ToF (time-of-flight) sensor. One party, either the mobile robot 105 or the docking station 100 sends a signal and the other party replies. The signal may be RF, laser and any signal detectable by an electronic device. The signal moves in a predefined and known speed, for example speed of light, speed of sound in case the signal is ultra-sonic and the like, and the distance is calculated according to the time elapsing until receiving the signal. In case the clock of the mobile robot 105 and the docking station 100 are in sync, there's no need for the second party to reply.

The pose detection manager 136 is configured to use the plurality of sensors of the sensor unit 120, to calculate the position of the mobile robot and store the calculated position in the memory 133. In some embodiments, the mobile robot 105 may utilize a symmetrical body that lacks a single front direction. In such cases, the mobile robot's 105 position is determined when the mobile robot moves, and then the position would be calculated as the advancing vector of the mobile robot 105. The position may include the mobile robot's general azimuth, direction of the mobile robot's front panel and the like.

The navigation manager 138 is configured to receive a stored location and a stored position of the mobile robot 105 from the memory 133. The navigation manager 138 is further configured to calculate a recharge navigation for bringing the mobile robot 105 to close proximity with the docking station 100. In some embodiments, a close proximity is considered to be about 0.5 meters from the docking station 100. In other embodiments, the navigation manager 138 can be omitted from the controller module 130 in cases the mobile robot 105 is capable of self-navigating to a close proximity to the docking station 100. The navigation manager 138 may utilize obstacles stored in the docking station storage, or in a remote device, when calculating the navigation path. The navigation manager 138 may use information collected by sensors of the mobile robot 105, or data received from sensors located remotely from both the docking station 100 and the mobile robot 105. Such information may enable the navigation manager to stop navigating the mobile robot 105, for example when a standalone sensor detects that the mobile robot 105 is within a predefined distance from the docking station 100.

The docking manager 139 is configured to guide the mobile robot from being in close proximity to the docking station 100 to precisely dock at the at least one of the charging unit 112 of the docking station 100. In some embodiments, the docking manager 139 is configured to receive a stored location and a stored position of a mobile robot 105 from the memory 133. Then, the docking manager 139 is configured to calculate a docking navigation, comprising specific advancing direction to be commenced by the mobile robot 105.

FIG. 2 discloses a schematic block diagram of a mobile robot navigation system comprising a docking station utilizing a remote server for controlling a mobile robot, according to exemplary embodiments of the subject matter. In some embodiments, a docking station 210 comprises a charging unit 211, a control unit 212 and a communication module 213. The charging unit 211 is configured to charge at least one mobile robot 230. The control unit 212 is configured to control the connection status and the charging process of the at least one mobile robot 230.

In some embodiments, the docking station 210 comprises the charging unit 211 and the communication module 213, as aforementioned in docking station 210, without the control unit 212. The docking station 210 is configured to charge at least one mobile robot 230, and to gather data from the sensors of the sensor unit 214. In further embodiments, the docking station 210 is configured to exchange communications with the remote controller device 220, and to serve as a relay station for communication arriving to and from the mobile robot 230.

In some embodiments, the remote controller device 220 of the mobile robot guidance system 200 is not part of the docking station 210 but rather a separate/distinct component of the system. In some embodiments, the remote controller device 220 may be embodied as a remote server, communicatively coupled with the docking station 210 and the mobile robot 230. In some embodiments, the communication connection between the remote controller device 220 and the mobile robot 230 is made through the docking station 210. The remote controller device 220 comprises the memory 222 as aforementioned, and a communication module 227, configured to exchange electrical signals with at least one of the docking station 210, the sensors of the sensor module 214, and other sensors located in the area outside the docking station, and with the mobile robot 230.

The remote controller device 220 is configured to receive and process data received from the docking station 210. In some embodiments, the remote controller device 220 receives data gathered from the sensor module 214 of the docking station 210. The remote controller device 220 is further configured to process the received data and to calculate the location of the mobile robot 230 using the robot detection manager 225. In order to calculate the location of the mobile robot 230, the remote controller device 220 may process visual data received from visual sensors of the sensor module 214 inspecting the space around the docking station 210. The visual sensors of the sensor module 214 are configured to detect mobile robots in line of sight with the docking station 210, and may comprise cameras, infrared readers and the like. Additionally, or in case the mobile robot 230 is not in the line of sight from the docking station 210, the remote controller device 220 may process data received from other sensors located in the area where the mobile robot 230 moves, such as EMF sensors and the like. The sensors of the sensor module 214 may detect wireless signals sent from the mobile robot's communication module 231 and identify the mobile robot's location according to the signal strength, for example via triangulation, or by correlating the signal strength with a map of the area.

The remote controller device 220 is further configured to calculate the position of the mobile robot 230 using the pose detection manager 224. The mobile robot's position may be represented by values of pitch/roll/yaw+x,y,z direction of a surface of the mobile robot's housing. For example, an exemplary position may be include a direction of the mobile robot's housing front surface. In some cases, the position is measured in a relative angle from the docking station. In other embodiments, when the mobile robot 230 travels in a 3-dimensional medium (such as air or water), or is capable of moving on the vertical axis, the mobile robot's position may comprise vertical angle and horizontal angle from the horizon. In some embodiments, the pose detection manager 224 calculates the position of the mobile robot 230 by constantly tracking the mobile robot's movement, according to the mobile robot's location. This way, the pose detection manager 224 may compute the mobile robot's position based on the mobile robot's current advancing direction derived from prior locations. In some embodiments, the mobile robot may not have a defined position due to the mobile robot's symmetrical shape and/or size. In such cases, the mobile robot's position may be determined based on the mobile robot's last movement vector.

The remote controller device 220 may also comprise a navigation manager 223 configured to calculate a recharge navigation path from the location of the mobile robot 230 to a close proximity to the docking station 210. The recharge navigation path may be calculated according to the mobile robot's location and position. The recharge navigation path is then sent to the mobile robot 230. In some embodiments, the recharge navigation path can be updated by the remote controller device 220 considering the mobile robot's movement and the data received from the docking station 210 in order to shorten the path, move around obstacles, expedite the navigation and the like.

When the mobile robot 230 is detected as being located in close proximity to the docking station 210, the remote controller device 220 utilizes docking manager 226 configured to calculate a docking navigation path and send the docking navigation path to the mobile robot 230. The docking navigation path is configured to bring the mobile robot 230 to a precise charging position in the at least one charging unit 211 of the docking station 210.

The mobile robot 230 comprises a communication module 231 configured to exchange signals with other devices, such as the remote controller 220 and the docking station 210. Such signals may be electrical signals, which may contain queries, commands, instructions and the like. The communication module 231 may use wireless signals, transferred via Wi-Fi, Bluetooth, and any wireless mechanism desired by the person skilled in the art. The mobile robot 230 also comprises a power source 232 configured to supply power to the mobile robot's components. Such power source 232 may be a battery charged by the docking station 210, or may be charged from a renewable energy source, such as solar energy, wind and the like. The mobile robot 230 also comprises an actuation module 233 configured to actuate the mobile robot 230. The actuation module 233 may be electrically coupled to the power source 232 and receive electrical power therefrom. The actuation module 233 may comprise wheels, arms, fins, propellers, motors and the like. The mobile robot 230 also comprises a processor 235 configured to process the signals received via the communication module 231. The processor 235 may also be configured to convert the signals to commands to be sent to the actuation module 233, for example adjust velocity, change direction, rotate and the like.

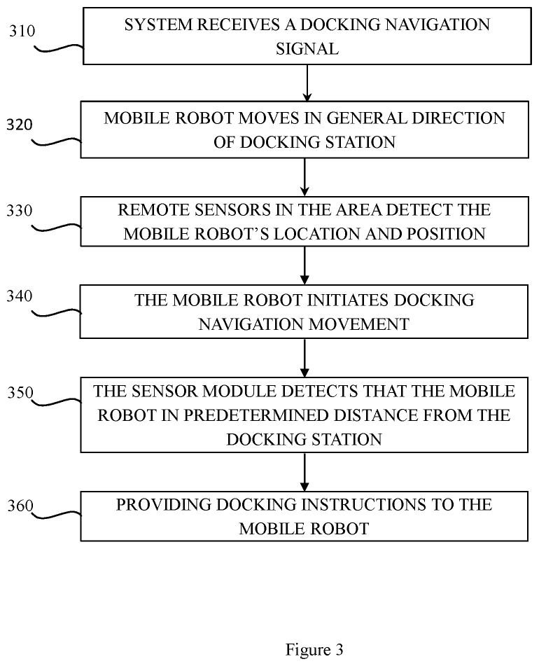

FIG. 3 illustrates a method for navigating a mobile robot to a docking station, according to exemplary embodiments of the subject matter. In some embodiments, the method is performed by the mobile robot navigation system 200 upon receiving a recharge navigation signal. In step 310, the mobile robot navigation system receives a docking navigation signal. In some embodiments, the docking navigation signal is sent by the mobile robot when the power in the mobile robot's power source is below a predetermined threshold. In other embodiments, the mobile robot periodically updates another device, such as the docking station, concerning multiple properties such as the power source status. In some other cases, the docking station may send a command for the mobile robot to return to the docking station in order to perform a specific task, such as to update software, send images and other data collected by the mobile robot to the docking station, and the like. In further embodiments, the recharge navigation signal may be sent by a user of the mobile robot, regardless of the mobile robot's power source status.

In step 320, after the docking navigation signal is received by the mobile robot, the mobile robot identifies the docking station's general direction and moves according to said general direction. Such general direction may be an azimuth. In step 330, one or more sensors located in the area where the mobile robot moves, detect the mobile robot's location. Such detection may be performed by capturing an image of the mobile robot, by identifying a property of the mobile robot, locking on the mobile robot's beacon and the like. The beacon may comprise Infra-Red, illumination module such as LEDs, QR code and the like. The sensors may detect wireless signals sent from the mobile robot's communication module and identify the mobile robot's location according to the signal strength, for example via triangulation, or by correlating the signal strength with a map of the area.

In some embodiments, the mobile robot's location may be determined in cooperation of a sensor located in the area, remotely and detached from the docking station, combined with the sensor module of the docking station. In some cases, the mobile robot's location may be calculated based on data collected by sensors located on the mobile robot. The remote controller device may receive data from sensor module of the docking station, process the received data combined with the data collected by the sensor located remotely from the docking station and calculate the location and/or position of the mobile robot. In some exemplary cases, the sensors located remotely from the docking station are located on mobile items, such as robots, automated vehicles and the like, which may move in accordance with commands from the remote controller.

After receiving a command to connect with the docking station, the mobile robot initiates movement towards the docking station, as disclosed in step 340. In some embodiments, the movement towards the docking station comprises a maneuver made by the mobile robot towards a general direction of the docking station. In some embodiments, the mobile robot 230 comprises self-navigation capabilities. In such cases, the recharge navigation initiation comprising the mobile robot advancing in the general direction of the docking station 210 independently until reaching a predefined distance from the docking station. In other cases, the mobile robot 230 does not include self-navigation capabilities. In such cases, the recharge navigation initiation includes providing the mobile robot 230 with guiding instructions, for example via the remote controller. The guiding instructions may comprise the distance from the docking station, the desired position to start the recharge navigation and the like. The basic guiding instructions are configured to bring the robot to close proximity with the docking station.

In some cases, the navigation towards the docking station is performed according to accurate commands from the docking station. The term accurate commands is defined specific properties sent by the docking station to the mobile robot. For example, move 2 meters in azimuth 45, when move 80 centimeters in azimuth 120 and the like. In the accurate command mode, the mobile robot only moves in response to specific commands from the docking station. In some exemplary cases, when the mobile robot is in the accurate command mode, the docking station sends commands limited to “rotate”, “stop rotating”, “move” and “stop moving”, excluding distances and directions. In such cases, the mobile robot only advances in a front direction defined by a front surface of the robot. Instead of providing a command of “move 55 centimeters”, the docking station sends a first command—“move”—and after the appropriate time, the docking station sends a second command—“stop moving”. In some cases, the commands in the accurate command mode may be to increase or decrease velocity.

In some exemplary cases, the docking station communicates with multiple mobile robots in the area. The multiple mobile robots send signals to the docking station, for example images, the mobile robots' locations, data from the robots' sensors and the like. The docking station may utilize the data sent from the multiple mobile robots in the area in order to calculate locations of at least one mobile robot of the multiple mobile robots in the area.

The recharge navigation initiation proceeds until the mobile robot is detected to be within a predefined distance from the docking station, as disclosed in step 350. In some embodiments, the mobile robot navigation system is configured to detect that the mobile robot is within predefined distance from the docking station using the sensor module. In some embodiments, the predefined distance is defined as an area of 0.5 meters around the docking station 210. In some embodiments, the mobile robot navigation system 200 constantly tracks the location and/or position of the mobile robot, either by calculating received movement data such as speed and angle, or by using the sensor module thereof. Furthermore, the mobile robot navigation system 200 may determine when the mobile robot 105 is in close proximity therewith by the tracking of the mobile robot 105.

In step 360, after the sensor module detects that the robot is within a predefined distance from the docking station, the mobile robot receives docking instructions, from at least one of the docking station and the remote controller. The docking instructions may include commands having specific direction and distance. For example, rotate 25 degrees clockwise and move 12 centimeters forward, move 15 centimeters at azimuth 165 and the like.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A method for guiding a mobile robot moving in an area to a docking station, the method comprising:
determining that the mobile robot is required to move to the docking station; the docking station obtaining a location and/or position of the mobile robot; upon detection of the mobile robot's location in the area, calculating a navigation path from the mobile robot's location to the docking station;
the mobile robot moving towards the docking station in accordance to the calculated navigation path;
identifying that the mobile robot is within a predefined distance from said docking station; and
generating docking commands to the mobile robot when located within the predefined distance from said docking station until the mobile robot docks into the docking station.

2. The method of claim 1, further comprises transmitting the calculated path to the mobile robot.

3. The method of claim 1, wherein the one or more sensors are movable in the area, wherein the one or more sensors receive a command to locate the mobile robot inside the area, the one or more sensors moving in the area until locating the mobile robot.

4. The method of claim 1, wherein the determining that the mobile robot is required to move to the docking station is performed according to charging properties of the mobile robot.

5. The method of claim 1, wherein calculation of the navigation path is performed by a remote server communicating with the docking station.

6. The method of claim 1, further comprising identifying the mobile robot within predefined distance from said docking station is performed according to images captured by a sensor module of the docking station.

7. The method of claim 1, further comprising identifying the mobile robot within predefined distance from said docking station is performed according to images captured by a sensor module of the mobile robot.

8. The method of claim 1, further comprising switching the mobile robot to an accurate command mode, in which the mobile robot only moves in response to specific commands from the docking station.

9. The method of claim 1, further comprising the docking station receiving signals from multiple mobile robots, at least one of the multiple mobile robots exchanges signals with the mobile robot or captures an image of the mobile robot, and further comprising calculating the mobile robot's location according to the signals received from multiple mobile robots.

10. The method of claim 1, further comprising the docking station receiving data collected by sensors located on the mobile robot, and further comprising calculating the mobile robot's location according to the data collected by sensors located on the mobile robot.

11. The method of claim 1, wherein the docking station receives a position of the mobile robot and calculates the navigation path according to the mobile robot's location combined with the mobile robot's position.

12-16. (canceled)

17. A docking system for guiding a mobile robot moving in an area to a docking station, the docking station comprises:
a docking station, comprising at least one charging unit, a communication module configured to exchange data with said mobile robot; and a controller module comprising a processor, a memory and a sensor module comprising one or more sensors;
wherein the sensor module is configured to track the mobile robot in the area once the mobile robot is required to move towards the docking station;
wherein the sensor module indicates to the docking station when the mobile robot is located within a predetermined distance from the docking station, and wherein the docking station is configured to provide docking instructions to the mobile robot for connecting the mobile robot to the at least one charging unit.

18. The docking system of claim 17, wherein the sensor module is further configured to calculate a recharge navigation path and send the recharge navigation path to said mobile robot.

19. The docking system of claim 17, wherein the controller module is configured to generate commands for docking the mobile robot to the docking station when the mobile robot is within a predefined distance from the docking station.

20. The docking system of claim 17, wherein at least one sensor of the sensor module is movable in response to a command from the docking station.

21. The docking system of claim 17, further comprising a secondary sensor module located in the area, remotely from the docking station, communicatively coupled with the docking station, wherein the docking station is configured to calculate the mobile robot's location according to information received from the secondary sensor module.

22. The docking system of claim 17, wherein the mobile robot is an autonomous vehicle and the area is a charging station.
